(19) United States
(12) Patent Application Publication
(10) Pub. No.: US 2022/0272135 A1
(43) Pub. Date: Aug. 25, 2022

(54) INTERACTIVE EVENT VIEWING METHOD AND SYSTEM

(71) Applicant: BLEACHR LLC, Minneapolis, MN (US)

(72) Inventors: Kristin Michelle Geer, Edina, MN (US); Bradley Charles Geer, Edina, MN (US)

(73) Assignee: BLEACHR LLC, Minneapolis, MN (US)

(21) Appl. No.: 17/652,436

(22) Filed: Feb. 24, 2022

Related U.S. Application Data
(60) Provisional application No. 63/153,507, filed on Feb. 25, 2021.

(51) Int. Cl. H04L 65/4038; H04L 65/1093

(52) U.S. Cl. CPC H04L 65/4038; H04L 65/1093; G06Q 30/0641

(57) ABSTRACT

Disclosed herein are a system and method for interactive event viewing. The system includes a plurality of servers communicatively coupled to a plurality of data sources. A plurality of users participate in more or more online events via one or more user devices. The system also includes a plurality of financial partners communicatively coupled to the system. The servers execute a method that includes receiving data from the plurality of data sources, converting the data into a video and audio feed, and providing the video and audio feed to the participants.

### RELATED APPLICATIONS

The present patent application claims priority from U.S. Provisional Patent Application No. 63/153,507, filed Feb. 25, 2021, which is incorporated by reference in its entirety herein.

### BACKGROUND

Currently many video conferencing tools exist. Examples include Zoom™ and Microsoft Teams™. These tools provide a face-to-face virtual experience for multiple people during a single event. The participants in the event are invited for the single event which they may participate in or not. These current tools do not provide an ability to access multiple face-to-face events. These current tools do not provide a platform to host multiple face-to-face events that can be open to the public, or alternatively open only to those invited by the organizer. It is desirable and beneficial to provide a tool including a platform and applications to host and participate in multiple online events.

### BRIEF DESCRIPTION OF THE DRAWINGS

FIG. 1 is diagram illustrating an interactive event viewing system according to an embodiment.

FIG. 2 is a screen shot of an application of the interactive event viewing system according to an embodiment.

FIG. 3A is a screen shot of an application of the interactive event viewing system according to an embodiment.

FIG. 3B is a screen shot of an application of the interactive event viewing system according to an embodiment.

FIG. 4A is a screen shot of an application of the interactive event viewing system according to an embodiment.

FIG. 4B is a screen shot of an application of the interactive event viewing system according to an embodiment.

FIG. 5 is a screen shot of an application of the interactive event viewing system according to an embodiment.

FIG. 6A is a screen shot of an application of the interactive event viewing system according to an embodiment.

FIG. 6B is a screen shot of an application of the interactive event viewing system according to an embodiment.

FIG. 7A is a screen shot of an application of the interactive event viewing system according to an embodiment.

FIG. 7B is a screen shot of an application of the interactive event viewing system according to an embodiment.

FIG. 8 is a screen shot of an application of the interactive event viewing system according to an embodiment.

FIG. 9 is a screen shot of an application of the interactive event viewing system according to an embodiment.

FIG. 10 is a screen shot of an application of the interactive event viewing system according to an embodiment.

### DETAILED DESCRIPTION

Disclosed herein are a method and system for interactive event viewing. The method and system are collectively and separately referred to herein as the Bleachr platform. The method and system facilitate interactive event viewing among different online group events that were originated or hosted by multiple hosts. In embodiments, participants (also referred to herein as users/patrons) will be able to visit any number of different types of face-to-face virtual events, which may be open to the public or viewed/scheduled as part of a private group. Potential categories of events include everything from meeting/hanging with a celebrity, attending a concert or comedy show, learning to cook from a celebrity chef or a craft from a maker/DIYer, learning from a thought leader, debating current events in a town hall discussion, etc.

In another aspect of the invention, content providers who are participants in the platform can be paid by through the Bleachr platform for the revenue that they generate from the content they provide in their channel of the Bleacher application (App). This revenue can be generated in various ways, including but not limited to: tips they earn from viewers; passes that they sell to their virtual events, potential revenue share from sponsor advertisement dollars generated during their virtual events (for content providers with large followings); products sold during their events; sponsor integration fees; and ad-share revenue. This allows for the commercialization of the content by streamers, rights holders and other content providers in a way that a current video conferencing platforms like cannot provide.

In an embodiment, the payment aspect of the platform includes a “tap to buy” feature that provides the framework for a virtual shopping channel similar to the Home Shopping Network on cable. In this case, fulfillment of the sale may not be carried out by the Bleachr platform, in which case the Bleacher platform is an intermediary through which a retailer or product manufacturer can host their own “shopping show” with a live host who interacts directly with potential purchasers and facilitate orders that the retailer/manufacturer fulfills.

In the following description of the drawings, an embodiment that is focused on sports event is shown. This is by way of example, yet as mentioned above, sports events are only one of many types of events or reasons for organizing meetings that can use the described methos and system.

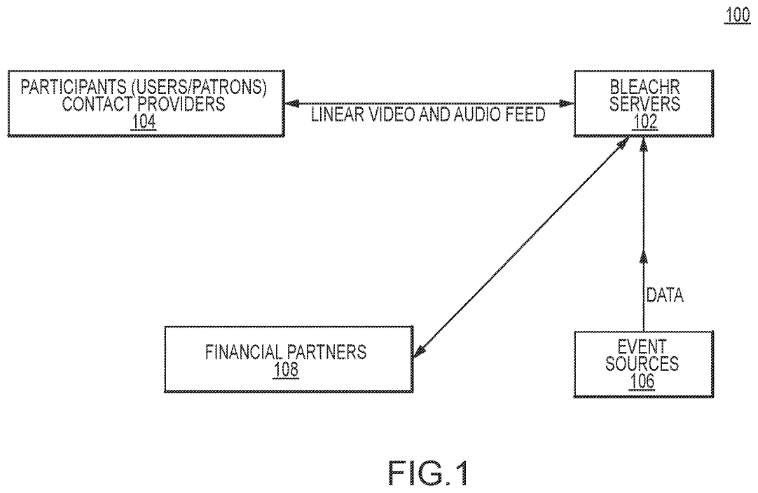

FIG. 1 is a diagram of an interactive event viewing system 100 according to an embodiment. Bleachr servers 102 include multiple processors and memory devices as known in the art. The multiple servers and memory devices serve the below described applications over the internet in the known fashion. The multiple servers can reside anywhere and can of any number. The servers 102 receive video and audio output from event sources 106 (also referred to herein as the Bleacher app) and convert the output (“data”) into a linear video and audio feed that is served to participants 104. Participants 104 include users, patrons and content providers.

Financial partners 108 include any known payment service providers. Financial partners 108 communicate with Bleacher servers 102 to facilitate and execute payments as previously described.

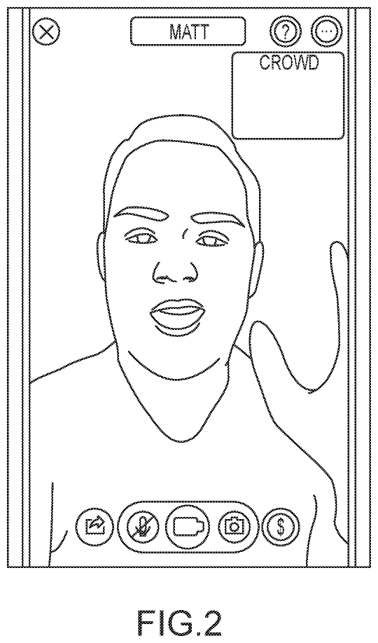

FIG. 2 through FIG. 10 are screen shots that illustrate various aspects of a participant experience according to an embodiment. This embodiment includes sporting events as the main focus, but embodiments are not so limited. The illustrated embodiment of the platform allows sports fans to watch team videos together, compete in trivia, show off their dance moves, etc. Participants engage through text chat, question button alerts, and by turning on their camera to chat face-to-face. A single organizer can start and share a live video experience and share with anyone via a unique generated link. Anyone possessing the link can turn on their camera or sit back and watch others participate.

The organizer is capable of flipping his/her camera and changing the view. The event organizer can also configure the “center stage” in a number of ways, including to incorporate dynamic 16:9 images, video or a webpage.

Sports organizations often look for ways to interact on a regular basis with their fan base to keep the team/tournament “top of mind”. Video “check-ins” provide a good way to do this, and a sports organization can become a participant and provide reward points to the fan for doing so.

FIG. 2 is a screen shot illustrating creation of a video check in according to an embodiment. In this example, a participant is using a smart phone to check in. Participants can use any computing device (“user device”) with a camera as well known in the art.

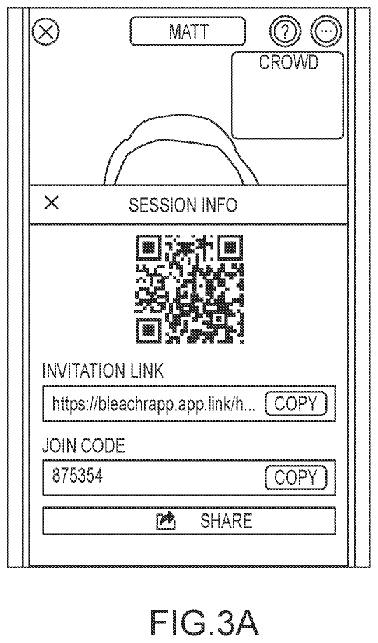

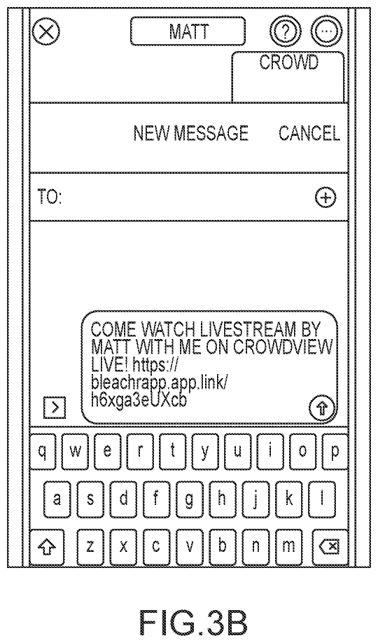

Referring to FIGS. 3A and 3B, there is an organizer for the event. The organizer clicks a “share” button to send an invitation for other to join.

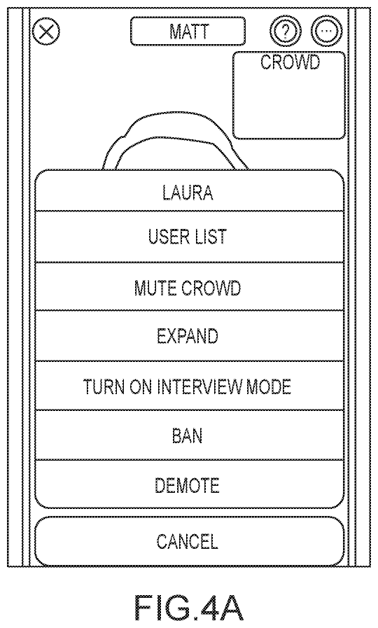

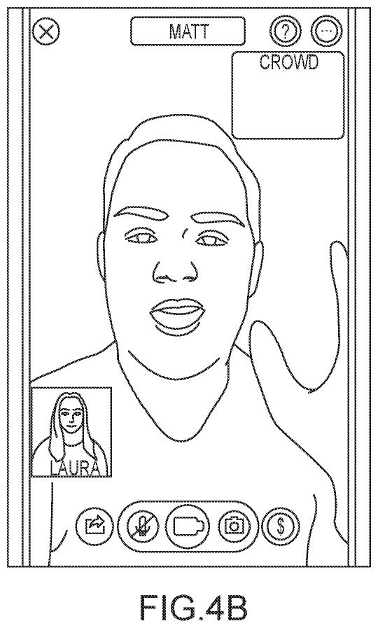

Referring to FIGS. 4A and 4B, once others have joined the organizer can promote or demote participants in the session. Any participant can screen record, completing the video check in.

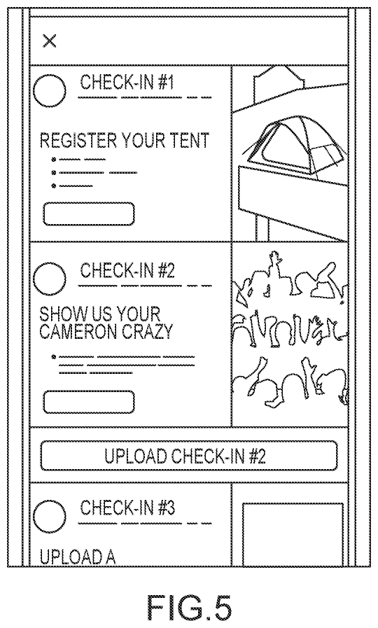

Referring to FIG. 5, a participant can select an “upload check in” button to check in with a fan group.

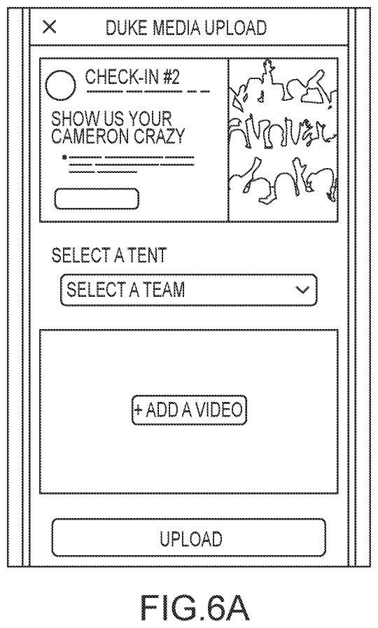

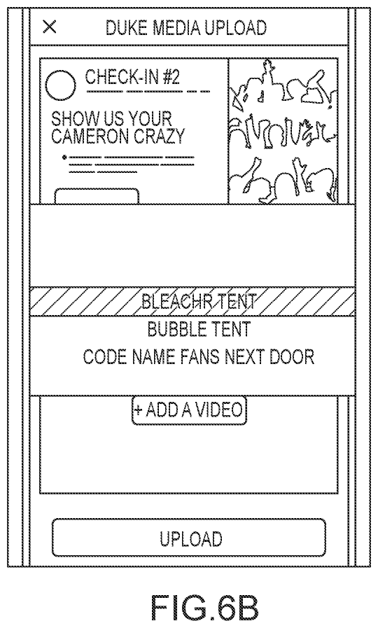

Referring to FIGS. 6A and 6B, a participant can choose his/her fan group from a dropdown menu.

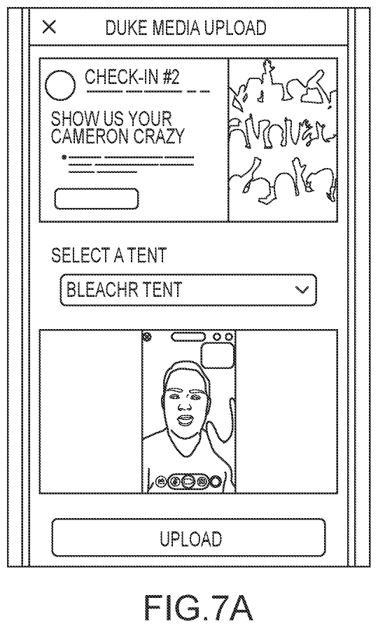

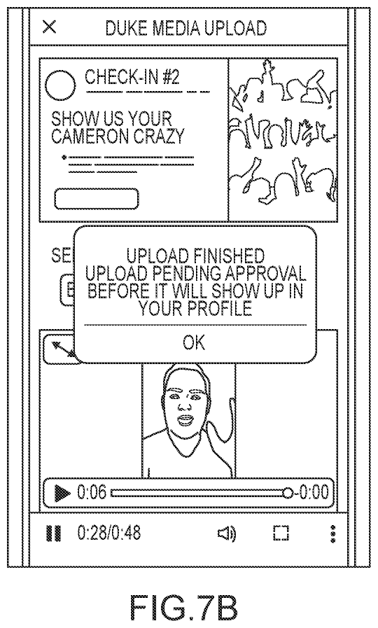

Referring to FIGS. 7A and 7B, a participant can choose a check in video from his/her camera roll. In an embodiment, the check in video is submitted to judges for approval.

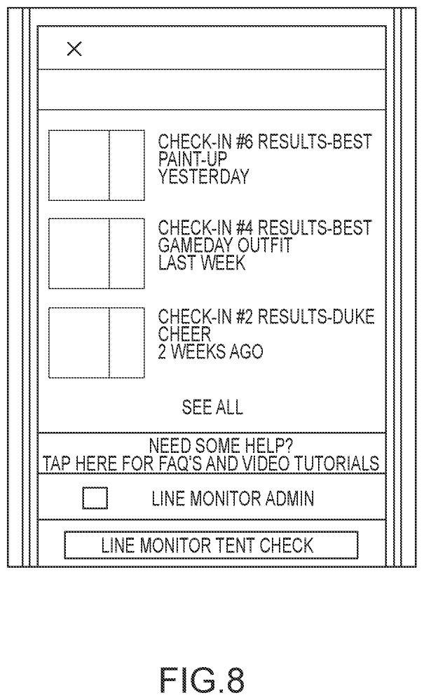

Referring to FIG. 8, designated content judges are able to approve, disapprove and rank submissions according to a moderation process that is a part of the system. Only designated judges with access to the system are able to perform judging functions.

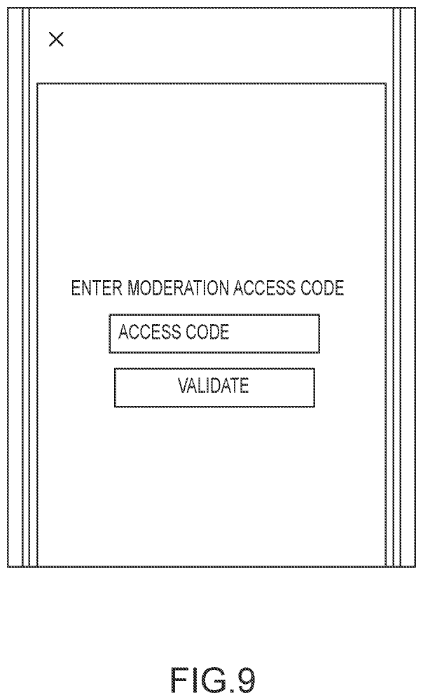

Referring to FIG. 9, a judge can enter a moderation access code to participate in the moderation process.

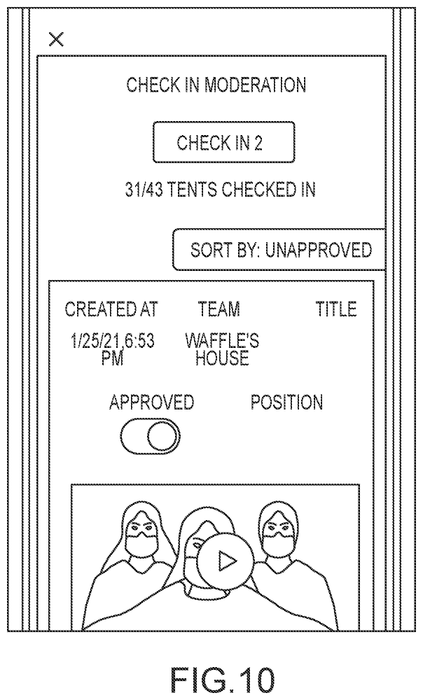

Referring to FIG. 10, once admitted to the moderation process, the admitted participant can select a check in that is to be moderated. The participant can then rank, approve, or disapprove the check in. Ranking or approving allows the check in submission to be viewed by other participants in the community. In this sense “community” refers to the group of participants as defined by the process described with reference to FIGS. 2 through 10. If a check in submission is disallowed, it cannot be viewed by the community.

Integration of the video and audio output from the Bleachr App into a linear television feed has been described. In other non-exclusive embodiments, the audio-out can also be integrated into a radio broadcast and provides a new dimension for talk radio (sports talk and otherwise). Now the host can place a phone on a small tripod in the studio and invite listeners to join the program via the Bleachr App. Rather than “calling-in” and expressing their views, the listeners can be face-to-face with the host in the Bleachr App to discuss whatever the topic is. The audio output from the Bleachr App can be simulcast through the radio program board and out as part of the broadcast. The “center stage” in the App can display video while the host and listeners are having their discussion, which adds an additional dimension to the program and discussion. This includes anything that is currently available on YouTube via integration with YouTube. For example, for example, in a sports talk radio show involving a discussion around the “big play in last night's big game”, the big play can be pulled-up via YouTube and displayed in the Bleachr App while listeners call in to discuss/debate with the program host.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts depicting examples of the methodology which may be used to conduct a goal-directed semantic search. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which will be set forth in the forthcoming claims.

What is claimed is:

1. A system for interactive event viewing comprising:
a plurality of servers communicatively coupled to,
a plurality of data sources;
a plurality of user devices that a plurality of participants use to participate in more or more online events via the user device; and
a plurality of financial partners; and
wherein the plurality of servers execute a method comprising,
receiving data from the plurality of data sources;
converting the data into a video and audio feed; and
providing the video and audio feed to the plurality of participants.

2. The system of claim 1, wherein the method further comprises:
allowing an organizer to define a group and start a live video experience and share the experience with anyone via a unique generated link; and
allowing the organizer to choose participants in the one or more online events.

3. The system of claim 2, wherein the method further comprises allowing a participant to record a video check in.

4. The system of claim 3, wherein the method further comprises allowing a participant to select an upload check in button to check in with the group.

5. The system of claim 4, wherein the method further comprises allowing a participant to choose a group from a plurality of groups using a dropdown menu.

6. The system of claim 1, wherein the method further comprises communicating with the financial partners to allow participants to be paid for revenue the participants generate from content that participants provide to the system.

7. The system of claim 6, wherein the method further comprises a tap to buy feature that provides a framework for virtual shopping.

8. The system of claim 6, wherein revenue can be generated by one or more of the following: tips earned from viewers; passes sold for virtual events; and products sold during events.

9. A method for interactive multiple event viewing and participation, the method comprising:
one or more processors receiving data from a plurality of data sources;
the one or more processors converting the data into a video and audio feed; and
the one or more processors providing the video and audio feed to a plurality of participants in one or more online events.

10. The methods of claim 9, further comprising:
allowing an organizer to define a group and start a live video experience and share the experience with anyone via a unique generated link; and
allowing the organizer to choose participants in the one or more online events.

11. The method of claim 10, wherein the method further comprises allowing a participant to record a video check in.

12. The method of claim 11, wherein the method further comprises allowing a participant to select an upload check in button to check in with the group.

13. The method of claim 12, wherein the method further comprises allowing a participant to choose a group from a plurality of groups using a dropdown menu.

14. The method of claim 9, wherein the method further comprises communicating with the financial partners to allow participants to be paid for revenue the participants generate from content that participants provide to the system.

15. The system of claim 14, wherein the method further comprises a tap to buy feature that provides a framework for virtual shopping.

16. The method of claim 15, wherein revenue can be generated by one or more of the following: tips earned from viewers; passes sold for virtual events; and products sold during events.

17. A non-transitory computer readable medium having stored thereon instructions, which when executed by a processor perform a method for interactive multiple event viewing and participation, the method comprising:
one or more processors receiving data from a plurality of data sources;
the one or more processors converting the data into a video and audio feed; and
the one or more processors providing the video and audio feed to a plurality of participants in one or more online events.

18. The medium of claim 17, further comprising:
allowing an organizer to define a group and start a live video experience and share the experience with anyone via a unique generated link; and
allowing the organizer to choose participants in the one or more online events.

19. The medium of claim 18, wherein the method further comprises allowing a participant to record a video check in.

20. The medium of claim 19, wherein the method further comprises allowing a participant to select an upload check in button to check in with the group.

21. The medium of claim 20, wherein the method further comprises allowing a participant to choose a group from a plurality of groups using a dropdown menu.

22. The medium of claim 17, wherein the method further comprises communicating with the financial partners to allow participants to be paid for revenue the participants generate from content that participants provide to the system.

23. The medium of claim 22, wherein the method further comprises a tap to buy feature that provides a framework for virtual shopping.

24. The medium of claim 23, wherein revenue can be generated by one or more of the following: tips earned from viewers; passes sold for virtual events; subscription fees; sponsor integration fees; ad-share revenue; and products sold during events.
